(19) United States
(12) Patent Application Publication
(10) Pub. No.: US 2009/0075624 A1
(43) Pub. Date: Mar. 19, 2009

(54) REMOTE VEHICLE INFOTAINMENT APPARATUS AND INTERFACE

(75) Inventors: STUART A. COX, Boca Raton, FL (US); Paul Marko, Pembroke Pines, FL (US); Stelios Patsiokas, Coral Springs, FL (US)

Correspondence Address: AKERMAN SENTERFITT, P.O. BOX 3188, WEST PALM BEACH, FL, 33402-3188, US

(73) Assignee: XM SATELLITE RADIO, INC., Washington, DC (US)

(21) Appl. No.: 12/136,665

(22) Filed: Jun. 10, 2008

Related U.S. Application Data
(60) Provisional application No. 60/973,380, filed on Sep. 18, 2007.

(51) Int. Cl. H04B 1/06; G06F 13/20

(52) U.S. Cl. 455/345; 710/313

(57) ABSTRACT

A remote application server that operates cooperatively with an embedded radio receiver (52) in a vehicle can include a standalone portable device (12 or 60) having memory (41) for storing and independently presenting audio or data wirelessly received by the embedded receiver and a communication interface (45) in the standalone portable device for receiving audio and data received at the embedded receiver and for transferring audio or data or both to and from a computer network (49) when coupled to the network and for uploading stored audio or data or both to a user interface (57) when coupled to the embedded receiver. The server can include a processor (46) in the standalone portable device for remotely running applications on the standalone portable device that are presented on the user interface coupled to the embedded receiver via a thin client (71) resident in the user interface or embedded receiver.

### CROSS-REFERENCE TO RELATED APPLICATIONS

This application claims the priority of U.S. Provisional Application No. 60/937,380, which was filed on Sep. 18, 2007 and which is incorporated herein in its entirety.

### FIELD OF THE INVENTION

The invention relates generally to user interfaces, and more particularly to a remote apparatus that interfaces with a vehicle's infotainment devices and services.

### BACKGROUND OF THE INVENTION

Vehicle Infotainment Freshness

OEM vehicle manufacturers are under increasing pressure to furnish their customers with rich and innovative infotainment equipment and services, including media (audio and video), navigation, safety and security, and connectivity services, all at the fingertips of drivers and passengers. As the consumer electronics industry provides an exploding array of media and services in consumer devices such as personal navigation devices (PND), cell phones, and music players, an expectation is set for vehicle systems to keep up with the latest gadgets, services, and innovative user interfaces. However, OEM development cycles are very long compared to consumer electronics, e.g., 3 to 5 years from specification to first vehicle sale. This means a customer buying a brand new model car is getting infotainment equipment with designs frozen 3 to 5 years earlier. Moreover, OEM equipment is generally not upgradeable as are many consumer devices, meaning a vehicle user experiences none of the rapid capability refreshes in their car that are the norm with consumer electronics.

Content Portability

In the specific arena of radio content (satellite digital audio radio service (SDARS), AM/FM, HD Radio, etc.), the car is often the primary listening environment for the vehicle driver and passengers. These content sources, provided through the built-in vehicle infotainment system, provide a rich assortment of programmed content and can engender strong listener loyalty for specific programs. For example, satellite radio has enjoyed rapid adoption, even at a monthly fee, thanks to the strength of professional content programming for over 170 channels from a single source. However, once the driver leaves the vehicle, this content is left behind in the built-in and non-portable infotainment system of the vehicle. Many consumers would like to take their favorite content programming with them, for example when parking their car to take a flight.

Vehicle Connectivity

A number of emerging vehicle infotainment services can be enabled or significantly enhanced by the ability to bring new or customized data into the vehicle's infotainment system, but the current ability to provide this enhancement is limited.

### SUMMARY

Embodiments in accordance with the invention herein attempt to address the “freshness issue” by providing a means for the vehicle manufacturer to (1) dramatically shorten the cycle time from specification to commercial introduction of new infotainment services for the vehicle from 3-5 years down to a year or less, and (2) continue to upgrade the vehicle infotainment systems through the life of vehicle ownership at “consumer electronics speed.” The embodiments herein also addresses the desire among consumers for “content portability” by providing a means for favorite content to be carried out of the vehicle on a very small portable, battery-powered device, so listening can continue outside the vehicle. Embodiments herein also enable vehicle connectivity by for example, a driver picking out a number of points of interest (POI) for an upcoming trip on a map/info service using a PC connected to the Internet where he or she might like to convey this POI information into their vehicle's navigation system so it's at their fingertips during a trip. In another example, a vehicle owner might want to collect vehicle diagnostics, travel and fuel history in an application running on a PC and/or on the embedded vehicle infotainment system to track usage and plan for proper maintenance. In another example, a driver might want to build a list of songs of interest or advertised products heard while driving, and easily bring those to their PC for further exploration or purchase over the Internet. Embodiments herein provide a simple method for conveying data between the vehicle infotainment system and a PC.

In a first aspect of the present invention, a remote application server system operating with an embedded radio receiver in a vehicle can include a standalone portable server having memory for storing and independently presenting audio and data wirelessly received by the embedded radio receiver in the vehicle, a user interface having a display coupled to the embedded radio receiver in the vehicle, and a communication interface in the standalone portable server for receiving audio and/or data received at the embedded radio receiver when coupled to the embedded radio receiver and for receiving audio and/or data from a computer network when coupled to the computer network and further for uploading stored audio and/or data to the user interface when coupled to the embedded radio receiver. The system can further include a processor in the standalone portable server for remotely running applications on the standalone portable server that are presented on the user interface coupled to the embedded radio receiver via a thin client resident in the user interface or embedded radio receiver in the vehicle. The applications running in the embedded radio receiver and the user interface in the vehicle remain unchanged. In other words, a thin client on the embedded radio or embedded user interface in the vehicle can present updated applications or new applications that are actually running on the standalone portable server. Further note, the standalone portable server further can operate as an independent portable digital audio recorder and player. The standalone portable server, the embedded radio receiver and the user interface communicate selectively via a proprietary communication link such as in the form of a digital transceiver and a standard communication link such as in the form of a universal serial bus. Further note, the standalone portable server can record multiple radio channels simultaneously received at the embedded radio receiver. The embedded radio receiver can be a digital audio radio receiver, a satellite digital audio radio receiver, or a frequency modulated digital audio radio receiver. The standalone portable server can remotely control hardware and software functions on the user interface in the vehicle. The system can include a processor resident in the vehicle for running applications on the user interface or the embedded radio receiver that are presented on a user interface integrated with the standalone portable server via a thin client resident in the standalone portable server.

In a second aspect of the present invention, a remote application server that operates cooperatively with an embedded radio receiver in a vehicle can include a standalone portable device having memory for storing and independently presenting audio and data wirelessly received by the embedded radio receiver in the vehicle and a communication interface in the standalone portable device for receiving audio and data received at the embedded radio receiver when coupled to the embedded radio receiver and for transferring audio and data to and from a computer network when coupled to the computer network and further for uploading stored audio and data to a user interface coupled to the embedded radio receiver when coupled to the embedded radio receiver. The server can further include a processor in the standalone portable device for remotely running applications on the standalone portable device that are presented on the user interface coupled to the embedded radio receiver via a thin client resident in the user interface or embedded radio receiver in the vehicle. The server can further include a thin client resident in the portable standalone device that uses a processor resident in the vehicle for running applications on the user interface or the embedded radio receiver that are presented on a user interface integrated with the standalone portable device via the thin client. The standalone portable device can further operate as an independent portable digital audio recorder and player. As noted above, the standalone portable device, the embedded radio receiver and the user interface can communicate selectively via a proprietary (or other) communication link in the form of a digital transceiver and a standard communication link in the form of a universal serial bus. The standalone portable device can record multiple radio channels simultaneously received at the embedded radio receiver. The standalone portable device can also remotely control hardware and software functions on the user interface in the vehicle.

In a third aspect of the embodiments, a connector arrangement between portable digital products and embedded automotive informational products can include a universal serial bus interface, a secondary communication link compatible with the universal serial bus interface, a mechanism for detecting the coupling of a universal serial bus connector or a connector using the secondary communication link compatible with the universal bus connector, and a switch mechanism for selectively enabling a link via secondary communication link when detecting the secondary communication link and enabling a connection via the universal serial bus interface when detecting a universal serial bus connector. The secondary connector can be a digital transceiver. The digital transceiver can provide an audio and data stream to and from a portable product and an embedded automotive informational product.

### BRIEF DESCRIPTION OF THE DRAWINGS

FIG. 1 illustrates a block diagram of a system using a remote application server working with an embedded receiver in a vehicle head unit in accordance with an embodiment of the present invention.

FIG. 2 illustrates another block diagram of a system using the remote application server of FIG. 1 in a vehicle having an embedded receiver in accordance with an embodiment of the present invention.

FIG. 3 illustrates the system of FIG. 2 with a new application running on the remote application server in accordance with an embodiment of the present invention.

FIG. 4 illustrates another block diagram of system using a remote application server working with an embedded receiver using a proprietary connection and/or USB connection in a vehicle in accordance with an embodiment of the present invention.

FIG. 5 illustrates another block diagram of a system using a remote application server and a thin client in the host system in accordance with an embodiment of the present invention.

FIG. 6 is a block diagram of system using a remote application server along with a vehicle infotainment system having a satellite radio in accordance with an embodiment of the present invention.

FIG. 7 is an illustration of a satellite radio digital transceiver communication link in accordance with an embodiment of the present invention.

FIG. 8 is a flow chart illustrating a method of remotely interfacing with a vehicle infotainment system in accordance with an embodiment of the present invention.

### DETAILED DESCRIPTION OF THE DRAWINGS

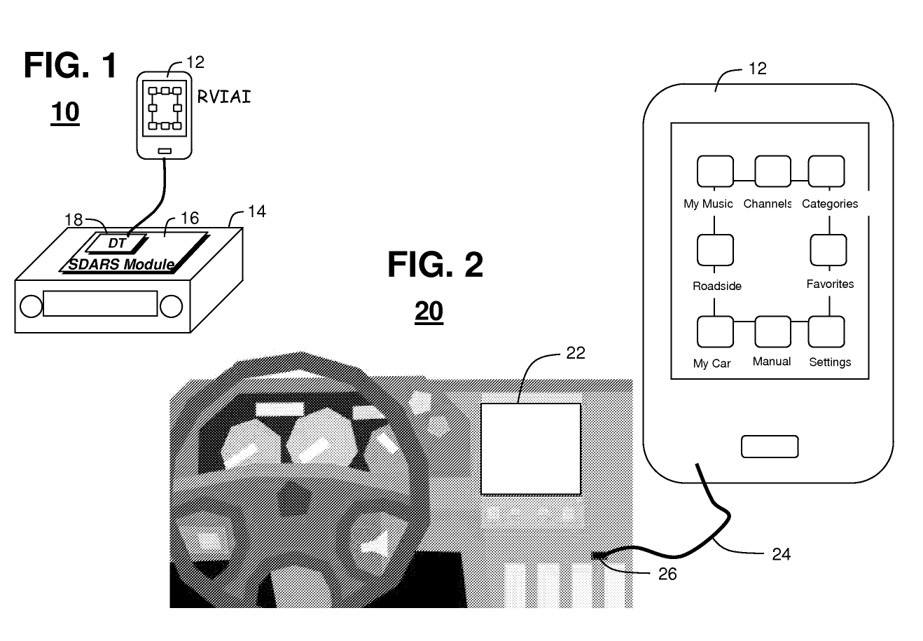

Referring to FIG. 1, a representative diagram of a system 10 having a remote vehicle infotainment apparatus and interface (RVIAI) 12 is shown in operation with an embedded radio receiver 16 that forms a portion of a vehicle's infotainment system or head unit 14. The RVIAI 12 and the embedded radio can communicate via a digital transceiver 18 which can be embedded in the embedded radio receiver 16

Referring to FIG. 2, another representative diagram illustrates a system 20 having a RVIAI 12 that interfaces with a vehicle's infotainment system and user interface 22. The RVIAI 12 can be linked to the vehicle's infotainment system via a port 26 that can be a wired connection 24. For example, the RVIAI 12 can be an OEM-branded accessory to a factory-installed satellite radio. The RVIAI 12 can connect to the satellite radio receiver already built in the car. The RVIAI 12 can bridge the car, home, and mobile environments. The RVIAI 12 can serve as a portable satellite radio playback device as an extension of the automotive satellite radio experience into a portable radio or home radio experience.

The RVIAI 12 can also bring new features into the vehicle at aftermarket speeds and brings new satellite radio features into the factory installed satellite (or other digital) radio.

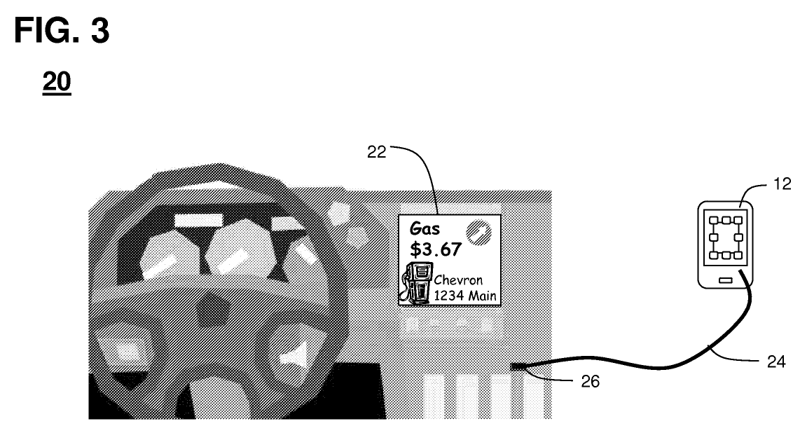

Referring to FIGS. 1-3, the RVIAI 12 can exhibit behavior that can include some of the following basic mechanisms for augmenting, extending, and/or replacing services (hereafter called “RVIAI Services”) built in to the Infotainment System:

Operator selects a menu or button choice from the Infotainment System that indicates a desire to use a RVIAI Service.

Infotainment System sends a signals and data over the Vehicle/RVIAI Link requesting enumeration of available RVIAI Services.

RVIAI software builds a list (menu) of available RVIAI Services and passes it over the Vehicle/RVIAI Link along with UI guidelines for the Infotainment System thin client.

Infotainment System displays the choices of RVIAI Services to the user using the Infotainment System UI.

User chooses a RVIAI Service from the menu using the Infotainment System controls.

Infotainment System sends a signals and data over the Vehicle/RVIAI Link indicating user's choice of a RVIAI Service.

RVIAI software constructs a further menu or information display representative of the selected RVIAI Service and conveys this information over the Vehicle/RVIAI Link along with UI guidelines for the Infotainment System thin client.

User responds to the displayed information, continuing to use the Infotainment System controls to interact with the RVIAI Service. As interaction proceeds, control and data is exchanged between the Infotainment System and RVIAI over the Vehicle/RVIAI Link, with the Infotainment System providing a thin client user interface while the RVIAI behaves as an application server.

This embodiment addresses the vehicle freshness issue through the following:

RVIAI Services execute on the RVIAI, not the Infotainment System. The Infotainment System merely provides a thin client user interface to the application software executing on RVIAI. Therefore the Infotainment System hardware/software does not require modification to introduce new RVIAI Services into the vehicle.

Since the RVIAI Services are operated by the Infotainment System controls, the RVIAI Service appears to the user as if they are “built-in” to the vehicle. The RVIAI device does not even have to be visible to the user when the RVIAI Services are used in the vehicle.

Whereas the Infotainment System hardware and software component design must be frozen 3 to 5 years before production, the RVIAI device can be developed in as little as a year. Moreover, a new RVIAI Service (application software) could be developed in even less than a year. This means that once an Infotainment System is designed with the necessary communications link for RVIAI and thin client software, adding new RVIAI Services is only a matter of developing a new RVIAI or installing new RVIAI Service software on an existing RVIAI. Therefore this invention enables the vehicle manufacturer to spin out new infotainment services at a cycle time matching the consumer electronics industry at time of vehicle introduction and throughout vehicle ownership, by simply developing new RVIAI devices and/or RVIAI application software.

The RVIAI 12 adds features to the vehicle system. For example, applications running on the RVIAI 12 can be presented on a user interface of the vehicle system. The vehicle can use a “thin client” user interface for user interaction. Note, the original vehicle software is not modified, but instead, applications can run on the RVIAI 12, under “remote control”. User interaction is with vehicle system controls while the RVIAI can even be hidden in glove compartment or elsewhere. The RVIAI 12 can introduce new applications into the vehicle years after factory installed system software is frozen.

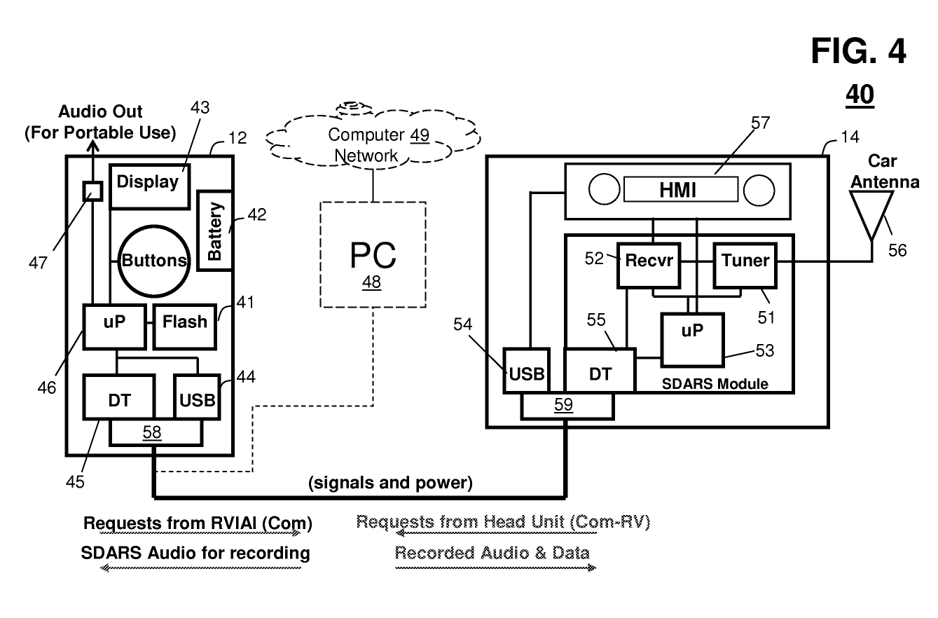

As illustrated in the system 40 of FIG. 4, the basic RVIAI 12 is similar to a portable media player and can include flash memory storage 41 for XM recordings, data, and MP3s, a battery 42, a display 43, a USB connection 44, a digital transceiver connection 45, a switch 58 for selecting the USB connection or the digital transceiver connection, a processor 46 and an audio port 47. The basic RVIAI does not necessarily include an internal satellite receiver since the RVIAI works cooperatively with the embedded vehicle receiver.

The system 40 can include a Head unit 14 that communicates to RVIAI 12 using an interface device which can be integrated in an SDARS module in the head unit. USB can be used for physical connection. Thus, as in the RVIAI 12, the head unit 14 can include a USB connector 54 and a digital transceiver 55 as well as a switch 59 for selecting the USB connection or the digital transceiver connection. The head unit 14 can further include a user interface 57, a tuner 51, and receiver 52 coupled to an antenna 56 as well as a processor 53.

The RVIAI 12 can record multiple satellite radio channels when vehicle is powered on. The RVIAI 12 can also perform automatic and on-demand recording, via the interface device. Out of the car, the RVIAI becomes a portable digital player, playing pre-recorded audio from satellite radio or from any other source. With sufficient memory, the RVIAI can play hours of captured satellite radio recordings. Furthermore, a user can manage the RVIAI from a vehicle infotainment system's controls. The RVIAI can support a rich roadmap of models and capabilities including Multi-channel portable satellite radio recorder/player capabilities, control recorded radio content and other RVIAI features through vehicle interface, Multi-media infotainment extension to factory vehicle interface. The RVIAI can also provide potential new services such as applications that provide customized information involving sports, stocks, weather, album art, gas prices, flight delays, audio books, podcasts, text-to-speech newspapers, video, speech interface, to just name a few. The RVIAI can also provide PC/Internet connectivity and link the car to the home via a computer 48 and a computer network connection 49. Further note that the software controlling the switch 58 in the RVIAI 12 or the switch 59 in the Head Unit 14 can detect the type of link attempting to hook up to the particular device. The software controlling the switch 58 or 59 will identify the link and negotiate which link to use, either the DT or USB connection in this particular example. The link will remain or use a USB connection as a default for any USB device.

The user can set preferences, import media and data at the PC and bring it into the car and for use with a boom-box, pedestrian headphone/antenna and other accessories for use outside the car. The RVIAI extends XM features or other satellite digital audio radio system (SDARS) features & benefits offered by factory installed receivers by enabling multi-channel recording, portable playback as an extension of the automotive radio experience. Furthermore, without an internal satellite radio receiver, the RVIAI can be very small with exceptional battery life.

The RVIAI can optionally bring new satellite radio or digital radio features into the factory installed radio equipment. The RVIAI can add new features not conceived when the factory installed automotive XM system was designed. The RVIAI is generally a portable XM (or other) digital player that docks with a factory installed automotive infotainment system. The RVIAI can share the satellite radio receiver built in the car. Further note that the RVIAI can be any consumer electronic device with an digital transceiver such as a cellphone, MP3 player, Personal Navigation Device (PND) or other portable device.

As noted, in one particular embodiment, the RVIAI can record multiple audio channels, for later playback away from the car and can include flash memory, color display, buttons, and an interface device where the Flash storage can store 100's of hours of recordings and the interface device or digital transceiver (DT) is used to connect to the automotive system. The automotive system can incorporate a digital transceiver as an interface. The interface or digital transceiver can be integrated into an OEM satellite radio receiver module. There are also a number of other options for connecting the RVIAI to the vehicle including but not limited to simple connector/cable connections, Built-in docks, Wireless connection (e.g. Bluetooth). Optionally, the RVIAI can share the vehicle screen & buttons for enhanced features. For example, the RVIAI can “paint” screens on vehicle factory installed display.

The RVIAI provides a number of benefits to OEM automobile manufacturers. The RVIAI closes the gap of satellite radio capabilities between OEM Factory Installed and Aftermarket satellite radios. As noted previously, the OEM design/launch timeframe is typically 3 years, whereas satellite radio feature innovation is much faster, resulting in guaranteed OEM lag behind aftermarket products. The technology gap increases over vehicle ownership time and thus the RVIAI augments factory installed (infotainment) systems with latest satellite radio or SDARS features at time of vehicle launch, and throughout vehicle ownership. Such an arrangement reduces OEM and supplier engineering/launch risk. SDARS services and features (or other technology features not necessarily related to XM) that are very new at time of vehicle system design can be deferred, since they can be potentially included with a future RVIAI release. Another benefit can include SDARS Subscription Conversion and Retention. OEMs can benefit with satellite radio from conversion and retention rate improvements supported by enhanced satellite radio features provided to the RVIAI user. The RVIAI can also be up-sold at vehicle purchase or as an add-on accessory. The RVIAI can optionally be skinned with OEM-specific markings and/or UI graphics to promote OEM brands outside the vehicle in an overall branding strategy.

Benefits to the OEM Supplier can include recording features that can be handled by the RVIAI and a satellite radio company-supplied software toolkit. Systems without storage can be equipped with “SDARS recording” without supplier hardware cost and engineering. Such an arrangement reduces OEM and supplier engineering/launch risk. SDARS services and features that are very new at time of vehicle system design can be deferred, since they can be potentially included with a future RVIAI release. The RVIAI interface hardware and software can be built into an SDARS OEM Module. The digital transceiver (DT) can be directly integrated into an SDARS OEM Module. The OEM Module software can be equipped to communicate with the RVIAI and an optional RVIAI UI Toolkit can be integrated into a supplier system. The supplier can map their UI controls to requisite RVIAI logical control functions such as buttons on head unit, touchscreen, steering wheel controls, etc. The toolkit provided by a satellite radio company can be used for rapid integration.

A satellite radio carrier or other subscription service can benefit by increased conversion and retention. For example, the increased value of a subscription (portable use, recording, advanced features) leads to conversion appeal when the RVIAI is used during a trial period and during vehicle ownership. Such as system also reduces natural obsolescence of Factory Installed satellite radio systems (or other systems) and can keep features “fresh” for factory installed systems. The system also can simplify synchronization of enhanced satellite radio services between a carrier and OEMs. For example, SDARS services and features that are very new at time of vehicle system design can be deferred, since they can be potentially included with a future RVIAI release.

The RVIAI model provides numerous benefits to the end user or customer. Such system provides the latest satellite radio features into the Factory Installed satellite radio systems and can also provide other updated features for other systems affiliated with the embedded infotainment system of the vehicle. The system enables recordings of favorite songs, time shifting, and cached content (podcasts). Emerging advanced features, such as enhanced sports info, speech control, and info services such as gas prices can be introduced or enhanced. Customers can enjoy satellite radio content (or other content) outside the vehicle with a compact portable device. Note that once recorded, there are no signal issues since RVIAI plays from voluminous internal recordings. The system can also provide for optional accessories for in-home and boombox play and no additional subscription fees would necessarily be required for out-of-vehicle playback of content. The RVIAI can optionally be used to convey SDARS-related data between the vehicle and the Internet, by docking RVIAI to a PC. The RVIAI can also facilitate music track purchases based on bookmarked XM tracks. A user can load SDARS-related vehicle preferences through a PC Dashboard application. For example, personalized points of interest (POI), SDARS Recording preferences, and favorites can be loaded.

There are a number of primary classes of use cases for the RVIAI as follows: (1) RVIAI as a Digital Radio Player (DRP); RVIAI recording multiple channels in background while user is driving; when disconnected from car the RVIAI can be a Digital Radio Player, playing previously recorded content; operating similar to a Nexus or “Pick-6 DRP”; RVIAI views head unit as if it is a satellite radio MiniTuner; (2) RVIAI as an Application Server; RVIAI provides users with new applications controlled by the head unit interface; GUI thin client runs in head unit, driven by RVIAI applications; New RVIAI application software is not loaded into head unit, but applications run on the RVIAI; (3) The RVIAI as a content transfer device; The RVIAI used to convey data from a PC to the car, and vice versa and provide simple file transfer.

For recording, the RVIAI views car system as a MiniTuner, controlled by common bus messaging. For remote operation and data retrieval, the car system views the RVIAI as a media device and application server for the car's thin client, using extensions.

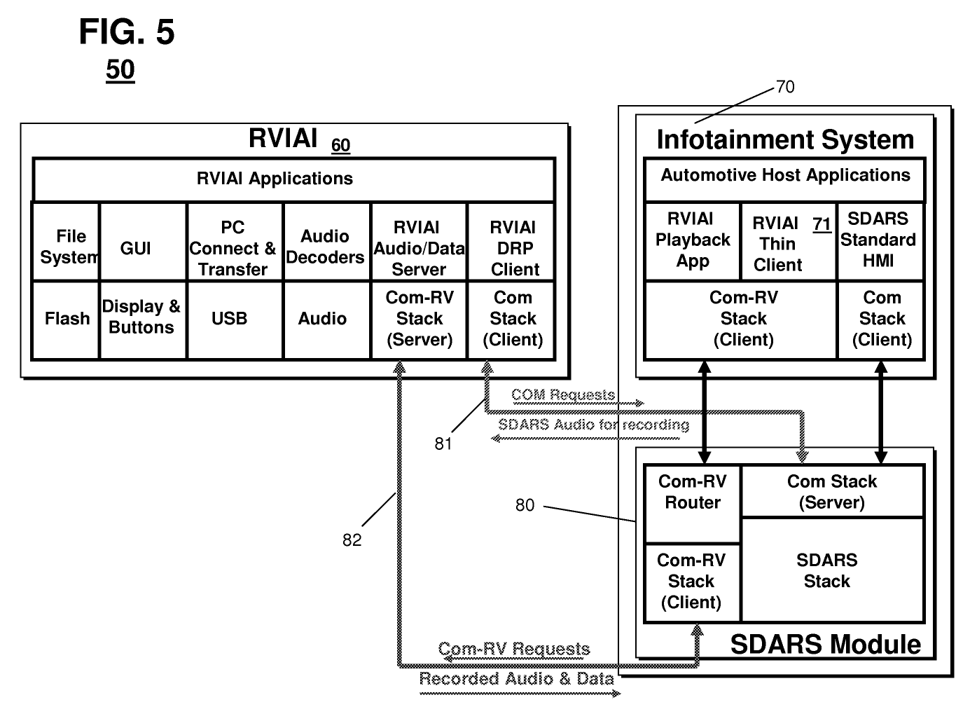

Referring to the system 50 of FIG. 5, the embodiment shown illustrates an arrangement addressing the vehicle freshness issue. The system 50 can generally include in one embodiment a portable electronics device 60 called the “RVIAI” (for remote vehicle infotainment apparatus and interface), incorporating a microprocessor, means for permanent data storage (e.g. flash memory or a hard drive), temporary data storage (e.g., RAM), a battery for powering the device, a user interface (e.g. buttons or a touch screen), a display, an external electrical and software interface for communicating data and media content with the vehicle infotainment system (e.g. USB, DT, Bluetooth, WiFi, UWB), an external electrical/software interface for communicating with a PC (e.g. USB, Bluetooth, WiFi, UWB), storage for software code and related data, and software executed by the microprocessor. The system 50 can further include a vehicle infotainment system 70 (herein called the Infotainment System) incorporating one or more microprocessors, temporary data storage (e.g. RAM), a user interface (UI) (e.g. buttons and/or a touch screen and/or speech interface), audio output, a means for communicating with the RVIAI device matching the communications capability supported by the RVIAI, optional means for permanent data storage (e.g. flash memory or a hard drive), storage for software code and related data, and software executed by the microprocessor. The system 50 can further include a means of connecting the RVIAI and Infotainment System (herein called the Vehicle/RVIAI Link 80 or links 80, 81 and 82) for purposes of transferring data, digital media, and control signals in both directions between the RVIAI and Infotainment System based on the shared communications capabilities of the RVIAI and Infotainment System (e.g. USB, DT, Bluetooth, WiFi, UWB).

The system 50 can further include software 71 incorporated in the Infotainment System 70 that provides a thin client user interface that allows the vehicle driver or passenger to control execution of software in the RVIAI using the built-in Infotainment System UI (the Infotainment System and enables the RVIAI and infotainment system to exhibit a client/server relationship for some functions). The system 50 also includes software incorporated in the RVIAI 60 that provides infotainment services that augment, extend, and possibly replace services built in to the Infotainment System. Furthermore, the system 50 can include software in the Infotainment System and RVIAI that support transmission of data and control signals between the Infotainment System and the RVIAI.

Operationally, the system 50 can have basic mechanisms for augmenting, extending, and/or replacing services (hereafter called “RVIAI Services”) built in to the Infotainment System. For example, an (user) operator can select a menu or button choice from the Infotainment System that indicates a desire to use a RVIAI Service. The Infotainment System 70 sends signals and data over the Vehicle/RVIAI Link 82 requesting enumeration of available RVIAI Services. The RVIAI software can build a list (or menu) of available RVIAI Services and passes it over the Vehicle/RVIAI Link 82 along with UI guidelines for the Infotainment System thin client. The Infotainment System 70 can display the choices of RVIAI Services to the user using the Infotainment System UI. The user can choose a RVIAI Service from the menu using the Infotainment System controls. The Infotainment System 70 sends signals and data over the Vehicle/RVIAI Link indicating user's choice of a RVIAI Service. The RVIAI software constructs a further menu or information display representative of the selected RVIAI Service and conveys this information over the Vehicle/RVIAI Link along with UI guidelines for the Infotainment System thin client. The user responds to the displayed information, continuing to use the Infotainment System controls to interact with the RVIAI Service. As interaction proceeds, control and data is exchanged between the Infotainment System and RVIAI over the Vehicle/RVIAI Link, with the Infotainment System providing a thin client user interface while the RVIAI behaves as an application server.

As previously noted, the RVIAI Services execute on the RVIAI, not the Infotainment System. The Infotainment System merely provides a thin client user interface to the application software executing on the RVIAI. Therefore the Infotainment System hardware/software does not require modification to introduce new RVIAI Services into the vehicle. Since the RVIAI Services are operated by the Infotainment System controls, the RVIAI Service appears to the user as if they are “built-in” to the vehicle. The RVIAI device does not even have to be visible to the user when the RVIAI Services are used in the vehicle.

The following embodiment description emphasizes the portability aspect of the RVIAI. As previously noted, the RVIAI incorporates a microprocessor, means for permanent data storage (e.g. flash memory or a hard drive), temporary data storage (e.g., RAM), a battery for powering the device, a user interface (e.g. buttons or a touch screen), a display, an external electrical and software interface for communicating data and media content with the vehicle infotainment system (e.g. USB, DT, Bluetooth, WiFi, UWB), an external electrical/software interface for communicating with a PC (e.g. USB, Bluetooth, WiFi, UWB), storage for software code and related data, software executed by the microprocessor, hardware or software for decoding stored audio and/or video content, and analog audio output circuitry and connectors (e.g. headphone jack and/or line out jack). The system further includes a vehicle infotainment system (herein called the Infotainment System) incorporating one or more microprocessors, temporary data storage (e.g. RAM), a user interface (UI) (e.g. buttons and/or a touch screen and/or speech interface), audio output, a means for communicating with the RVIAI device matching the communications capability supported by the RVIAI, optional means for permanent data storage (e.g. flash memory or a hard drive), storage for software code and related data, software executed by the microprocessor, and a radio receiver (e.g. SDARS, AM/FM, HD, etc.) capable of providing received digital audio content for one or more channels. The system can include a means of connecting the RVIAI and Infotainment System (herein called the Vehicle/RVIAI Link) for purposes of transferring data, digital media, and control signals in both directions between the RVIAI and Infotainment System based on the shared communications capabilities of the RVIAI and Infotainment System (e.g. USB, DT, Bluetooth, WiFi, UWB). The system can also include Software incorporated in the Infotainment System that provides for conveyance of digital media from the radio receiver to the RVIAI and for receiving digital media from the RVIAI. The system can also include Software incorporated in the RVIAI that sends proper signals and controls to the Infotainment System over the Vehicle/RVIAI Link to cause digital media from the radio receiver to be sent from the Infotainment System to the RVIAI. Other software in the system can include Software incorporated in the RVIAI and Infotainment System that allow digital media recorded in the RVIAI to be sent over the Vehicle/RVIAI Link to the Infotainment System for playback by the Infotainment System under user control. Software incorporated in the RVIAI that allows the user to control playback of digital media recorded in the RVIAI when the RVIAI is used disconnected from the vehicle. Other Software incorporated in the RVIAI can provide a user interface using RVIAI controls so the user can set preferences for media recording.

Operationally, such a system can allow a user to optionally establish recording preferences using the RVIAI interface and establish channels, genre, specific programs, etc. desired for recording. When connected to the vehicle Infotainment System using the Vehicle/RVIAI Link, the RVIAI can send signals and data over the Vehicle/RVIAI Link requesting that the radio receiver in the Infotainment System send digital audio content to the RVIAI for selected channels. (This operation can occur in the background while the user operates the car, perhaps listening to different radio content in the foreground). The RVIAI can store the received digital audio in its local storage, along with metadata identifying the content, source, etc. When the user leaves the vehicle, the user can disconnect the RVIAI from the vehicle and carry it with them outside the vehicle. The user can plug in headphones and use the battery-powered RVIAI to play content that was previously recorded while connected to the vehicle. With the RVIAI connected to the vehicle, the user also has the option of invoking RVIAI to play back the stored content using the controls and interface of the built-in vehicle Infotainment System. The RVIAI quietly and automatically can collect content from the radio built into the vehicle Infotainment System, recording one or more channels while the user is driving around. Preferences explicitly established by the user or programmatically derived by RVIAI guide the recording of channels and programs of highest interest to the user. When the user leaves the car, they take the battery-powered RVIAI with them, enjoying playback of the stored content on a small devices similar to a portable MP3 player. The RVIAI can also be connected to a home stereo system, boom-box, etc. thus providing full content portability from the car to the other arenas of life.

The following descriptions emphasize the vehicle connectivity aspect of the RVIAI. Beside the other hardware elements previously described, the system can include a means of connecting the RVIAI and a PC (the PC/RVIAI Link) for purposes of transferring data, digital media, and control signals in both directions between the RVIAI and PC based on the shared communications capabilities of the RVIAI and PC (e.g. USB, Bluetooth, WiFi, UWB). The system can include Software incorporated in the Infotainment System that receives data from and transmits data to the RVIAI over the Vehicle/RVIAI Link and Software incorporated in RVIAI that receives data from and transmits data to a connected PC over the PC/RVIAI Link, and software incorporated in the RVIAI that receives data from and transmits data to a connected Infotainment System over the Vehicle/RVIAI Link. The system can also include Application software in the Infotainment System that either uses or provides data that is conveyed from a PC (or indirectly from the PC Internet connection) via the RVIAI. The system can include application software on the PC (or connected Internet) that either uses or provides data that is conveyed from or to the Infotainment System via the RVIAI. Optional application software on the RVIAI can use or provide data that is conveyed from or to the Infotainment System or PC to or from the RVIAI. Operationally, such a system can have User operations application software running on a PC, including applications that incorporate interactions with web sites. The application software might generate data useful to have in the vehicle Infotainment System, such as personalized points of interest (POI) for navigation, personalized vehicle settings (e.g. does horn alert when unlocking with key FOB), customized playlists for MP3 playback, personal to-do reminders, and so forth. The RVIAI can be connected to the PC using the PC/RVIAI Link, and cooperative software running on RVIAI and the PC can transfer data created by the aforementioned PC software from the PC to the RVIAI. The user can connect the RVIAI to the vehicle using the Vehicle/RVIAI Link, and cooperative software running on RVIAI and the Infotainment System can transfer the aforementioned data from the RVIAI to the Infotainment System. Application software built into the Infotainment System can store and use the transferred data to influence behavior of the Infotainment System. The combination of the vehicle connectivity functions of RVIAI with either or both of the functions that address the vehicle freshness and content portability issues should be considered quite novel.

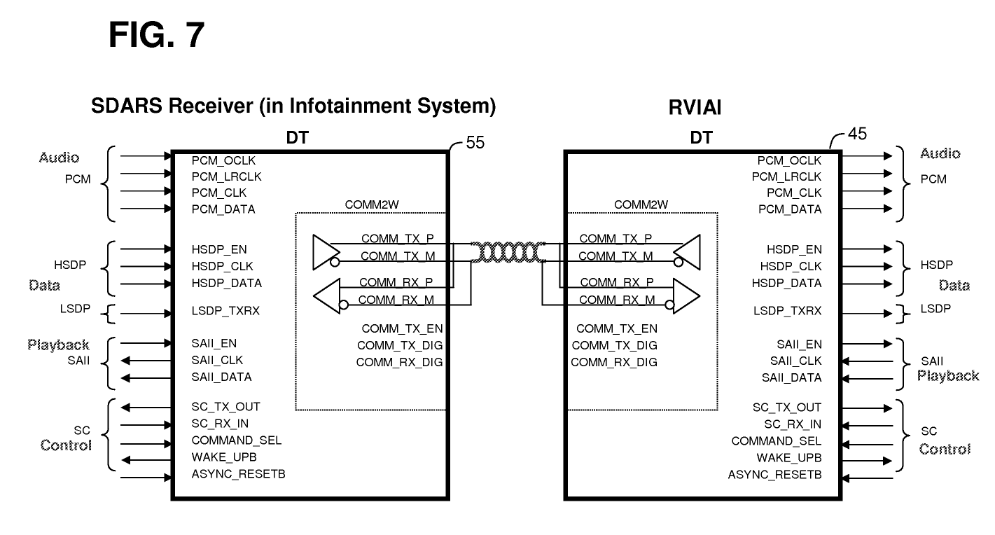

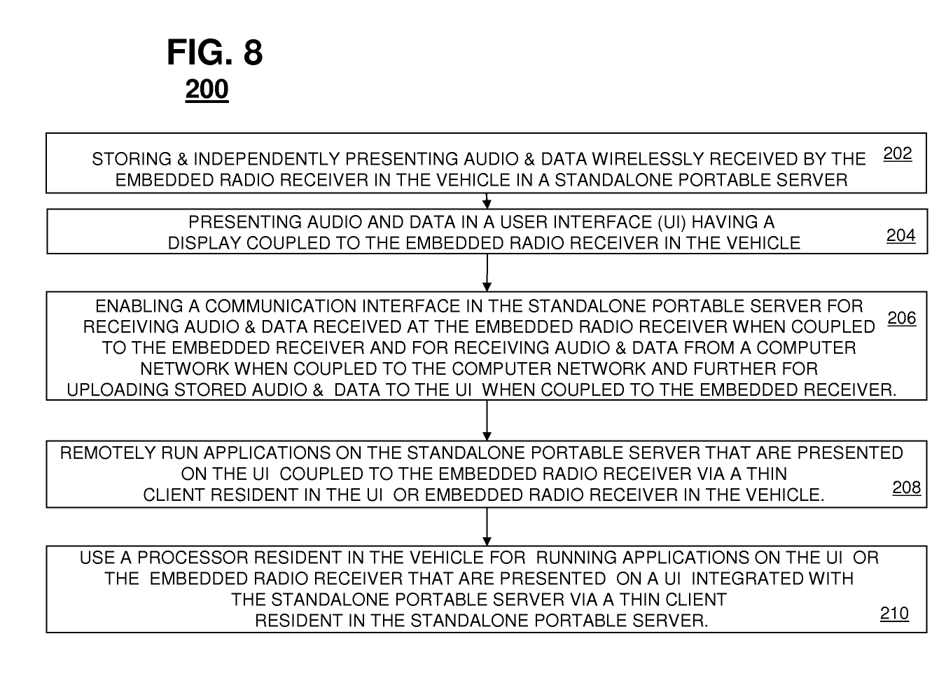

In one particular embodiment, vehicle freshness, content portability, and vehicle connectivity are addressed. In such an embodiment, the system can include a portable electronics device as previously noted called “RVIAI”, incorporating a microprocessor, means for permanent data storage (e.g. flash memory or a hard drive), temporary data storage (e.g., RAM), a battery for powering the device, a user interface (e.g. buttons and/or a touch screen), a display, an external electrical and software interface for communicating data and media content with the vehicle infotainment system based on a DT (Digital Transceiver), an external electrical/software interface for communicating with a PC based on USB, storage for software code and related data, software executed by the microprocessor, software for decoding stored audio content, and analog audio output circuitry and connectors (headphone jack and line out jack). The system can further include a vehicle infotainment system incorporating at least one microprocessor, temporary data storage (e.g. RAM), a user interface (UI) (e.g. buttons and/or a touch screen and/or speech interface), audio output, a means for communicating with the RVIAI device matching the communications capability supported by the RVIAI, optional means for permanent data storage (e.g. flash memory or a hard drive), storage for software code and related data, software executed by the microprocessor, and an SDARS radio receiver capable of providing received digital audio content for one or more channels. The system can further include a means of connecting the RVIAI and Infotainment System (the Vehicle/RVIAI Link) for purposes of transferring data, digital media, and control signals in both directions between the RVIAI and Infotainment System based on the shared communications capabilities of the RVIAI and Infotainment System based on a digital transceiver such as the DT as further detailed in FIG. 7.

The system can further include a means of connecting the RVIAI and a PC (herein called the PC/RVIAI Link) for purposes of transferring data, digital media, and control signals in both directions between the RVIAI and PC based on the shared communications capabilities of the RVIAI and PC, based on USB. The following software can also be included: a) Software incorporated in the Infotainment System that provides a thin client user interface that allows the vehicle driver or passenger to control execution of software in the RVIAI using the built-in Infotainment System UI (the Infotainment System and RVIAI exhibit a client/server relationship for some functions); b) Software incorporated in the RVIAI that provides infotainment services that augment, extend, and possibly replace services built in to the Infotainment System; c) Software in the Infotainment System and RVIAI that support transmission of data and control signals between the Infotainment System and RVIAI; d) Software incorporated in the RVIAI that sends proper signals and controls to the Infotainment System over the Vehicle/RVIAI Link to cause digital media from the radio receiver to be sent from the Infotainment System to the RVIAI; e) Software incorporated in the RVIAI and Infotainment System that allow digital media recorded in the RVIAI to be sent over the Vehicle/RVIAI Link to the Infotainment System for playback by the Infotainment System under user control; f) Software incorporated in the RVIAI that allows the user to control playback of digital media recorded in the RVIAI when the RVIAI is used disconnected from the vehicle; g) Software incorporated in the RVIAI that provides a user interface using RVIAI controls so the user can set preferences for media recording; h) Software incorporated in RVIAI that receives data from and transmits data to a connected PC over the PC/RVIAI Link, and software incorporated in RVIAI that receives data from and transmits data to a connected Infotainment System over the Vehicle/RVIAI Link; i) Application software in the Infotainment System that either uses or provides data that is conveyed from a PC (or indirectly from the PC Internet connection) via the RVIAI; j) Application software on the PC (or connected Internet) that either uses or provides data that is conveyed from the Infotainment System via the RVIAI; and k) Optional application software on the RVIAI that uses or provides data that is conveyed from the Infotainment System or PC to the RVIAI. The behavior and use of the embodiment of the invention combines the behaviors previously described above.

Variations of the embodiments described above can include, but is not limited to the following: a) A RVIAI that only serves to solve the vehicle freshness issue, i.e. providing new applications to the Infotainment System through the thin client/server model, but without ability to record audio content for portable use; b) A RVIAI that only serves to solve the content portability issue, i.e. recording content and data from the vehicle Infotainment System for playback outside the vehicle, but without the ability to provide new applications for the vehicle; c) A RVIAI that combines vehicle connectivity concepts (e.g. transfer between PC and vehicle) with either and both of the above two concepts.

The connectivity between the RVIAI and vehicle Infotainment System (Vehicle/RVIAI Link) can use any of the following connection technologies without limitation: USB, DT signal transmitted over physical USB connection, Bluetooth, WiFi, UWB, Vehicle Bus, and other wireless or wired connection capable of bidirectional data transmission. Connectivity between the RVIAI and a PC (PC/RVIAI Link) can use any of the following connection technologies: a) Bluetooth b) WiFi c) UWB d) Firewire e) Other wireless or wired connection capable of bidirectional data transmission. Transfer of data between the PC and the RVIAI, and/or the RVIAI and the Infotainment System can use for example: a) the MSC profile and protocol for USB or b) the MTP profile and protocol for USB.

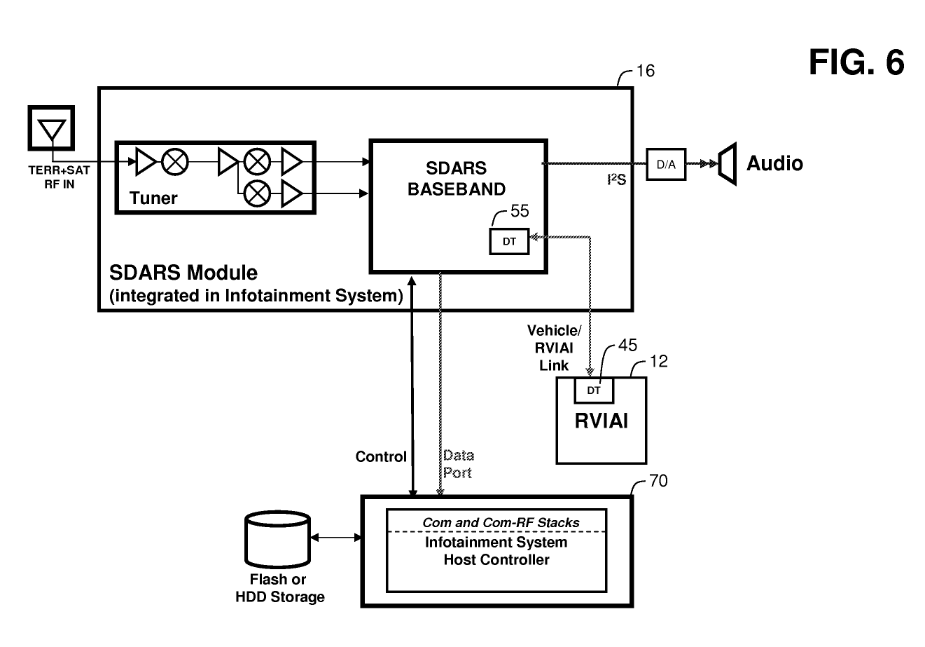

Referring to FIGS. 6-7 transfer of data and signals between the RVIAI and Infotainment System (Vehicle/RVIAI Link) using DT can enable several enhancements. For example, control from the RVIAI and digital media content from the RVIAI to the Infotainment System are multiplexed over the DT signals using protocol headers that distinguish control signals (such as required for thin client operations) from digital audio (such as required for audible playback by the SDARS baseband receiver in the Infotainment System). Control from the Infotainment System and digital media content from the Infotainment System to the RVIAI can be multiplexed over the DT communication control signals using protocol headers that distinguish normal SDARS radio control signals (such as required for recording content and monitoring radio behavior) from auxiliary control signals and data (such as required for thin client operations). Control from the Infotainment System and digital media content from the Infotainment System to the RVIAI are multiplexed over the DT signals using protocol headers that distinguish normal SDARS data services (such as required for recording content and receiving SDARS data services) from auxiliary control signals and data (such as required for thin client operations).

Several technical variations can also be made in the context of a satellite digital audio radio along with the use of a digital transceiver. For example, the DT interface in the Infotainment System can be supplied by an on-chip integration of the DT interface into the SDARS baseband device of the vehicle satellite radio receiver which provides overall efficiency in terms of space. The DT interface in the Infotainment System can also be supplied by a separate DT interface chip which discretely interfaces with one or more microprocessors in the Infotainment System and the SDARS baseband device.

Provisioning of the RVIAI with Application Software that interacts with the Infotainment System can be achieved through installation of the Application Software when the RVIAI is manufactured or through installation of the Application Software through a connection with a PC, wherein the Application Software is distributed to the PC through download from the Internet, from a CD, or other typical means of software distribution. Alternatively or optionally, installation of the Application Software can be download over the air through the SDARS system wherein the RVIAI receives the new application software when connected to the Infotainment System. Installation of the Application Software can also be downloaded over the air through other wireless receivers in the vehicle Infotainment System such as HD radio, WiFi, UMW, WiMAX, etc.

Application Software on RVIAI that interacts with the Infotainment System (client/server model) can be provided in several iterations. For example, all data required for the Application Software can be resident on the RVIAI, or all or portions of the data required for the Application Software can be received by the RVIAI from the Infotainment System, or all or portions of the data required for the Application Software can be received by the RVIAI from the SDARS radio incorporated in the Infotainment System, or all or portions of the data required for the Application Software can be received and stored by the RVIAI through a previous PC/RVIAI connection session, or all or portions of the data required for the Application Software is received by the RVIAI by download over the air through other wireless receivers in the in the vehicle Infotainment System such as HD radio, WiFi, UMW, WiMAX, etc.

As previously noted, the RVIAI can be embodied in various feature variations where for example, the RVIAI comes with no display, for a low cost implementation or without a battery for another low cost and size implementation, particularly if used primarily to address vehicle freshness and/or vehicle connectivity issues only. In another version the RVIAI can be embodied in a form that records and buffers audio content currently listed in the vehicle in temporary storage (e.g. RAM), so that the vehicle user can temporarily pause, resume, and repeat the audio content for some period of time such as an hour. Other optional features can include Text to speech capability (TTS), allowing RVIAI to generate speech responses to user interactions and programmatically detected events that are heard through the audio system of the Infotainment System, and/or the RVIAI audio output. The RVIAI can optionally include Automatic Speech Recognition (ASR) capability, allowing RVIAI to recognize spoken commands by the user wherein audio input is from a microphone incorporated in the vehicle Infotainment System or a microphone input incorporated in RVIAI. The RVIAI can also optionally include Text to speech capability for interactively reading books and/or periodicals supplied to RVIAI through the Infotainment System, radio in the Infotainment System, or through a PC connection. Other variations can include Video playback capability or where the RVIAI is a cell phone, a traditional digital music player, or a Personal Navigation Device (PND). Among the various embodiments described above, the RVIAI can be used to record any of the following from the Infotainment System such as audio from one or more channels of SDARS content, audio from one or more channels of HD radio, audio from AM or FM, streamed media from WiMAX, WiFi, or other high speed wireless communication link, Data services and information received from any of the above sources, such as stock and financial reports, sports, weather, news, traffic, navigation map updates, POI updates, gas prices, movie schedules, flight delays, business coupons, audio program metadata, etc., and Video.

Referring to FIG. 8, a method 200 of interfacing with a vehicle infotainment system having an embedded radio receiver in a vehicle can include the step 202 of storing and independently presenting audio and data wirelessly received by the embedded radio receiver in the vehicle in a standalone portable server having memory and further presenting audio and data in a user interface having a display coupled to the embedded radio receiver in the vehicle at step 204. The method 200 can further enable a communication interface in the standalone portable server for receiving audio and data received at the embedded radio receiver when coupled to the embedded radio receiver and for receiving audio and data from a computer network when coupled to the computer network and further for uploading stored audio and data to the user interface when coupled to the embedded radio receiver at step 206. The method 200 can also include the step 208 of remotely running applications on the standalone portable server that are presented on the user interface coupled to the embedded radio receiver via a thin client resident in the user interface or embedded radio receiver in the vehicle. The method 200 can also use a processor resident in the vehicle for running applications on the user interface or the embedded radio receiver that are presented on a user interface integrated with the standalone portable server via a thin client resident in the standalone portable server at step 210.

It should be realized that embodiments in accordance with the present invention can be realized in hardware, software, or a combination of hardware and software. In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

We claim:

1. A remote application server system operating with an embedded radio receiver in a vehicle, comprising:
a standalone portable server having memory for storing and independently presenting audio or data wirelessly received by the embedded radio receiver in the vehicle;
a user interface having a display coupled to the embedded radio receiver in the vehicle; and
a communication interface in the standalone portable server for receiving audio or data received at the embedded radio receiver when coupled to the embedded radio receiver and for receiving audio or data from a computer network when coupled to the computer network and further for uploading stored audio and data to the user interface when coupled to the embedded radio receiver.

2. The remote application server system of claim 1, wherein the system further comprises a processor in the standalone portable server for remotely running applications on the standalone portable server that are presented on the user interface coupled to the embedded radio receiver via a thin client resident in the user interface or embedded radio receiver in the vehicle.

3. The remote application server system of claim 1, wherein applications running in the embedded radio receiver and the user interface in the vehicle remain unchanged.

4. The remote application server system of claim 1, wherein the standalone portable server further operates as an independent portable digital audio recorder and player.

5. The remote application server system of claim 1, wherein the standalone portable server, the embedded radio receiver and the user interface communicate selectively via a proprietary communication link and a standard communication link.

6. The remote application server system of claim 5, wherein the standalone portable server, the embedded radio receiver and the user interface communicate selectively via a proprietary communication link in the form of a digital transceiver and a standard communication link in the form of a universal serial bus.

7. The remote application server system of claim 1, wherein the standalone portable server records multiple radio channels simultaneously received at the embedded radio receiver.

8. The remote application server system of claim 1, wherein the embedded radio receiver is a digital audio radio receiver, a satellite digital audio radio receiver, or a frequency modulated digital audio radio receiver.

9. The remote application server system of claim 1, wherein the standalone portable server remotely controls hardware and software function on the user interface in the vehicle.

10. The remote application server system of claim 1, wherein the system further comprises a processor resident in the vehicle for running applications on the user interface or the embedded radio receiver that are presented on a user interface integrated with the standalone portable server via a thin client resident in the standalone portable server.

11. The remote application server system of claim 1, wherein the remote application server system receives and uploads data to the user interface including traffic, gas prices, movie schedules or flight delays.

12. A remote application server that operates cooperatively with an embedded radio receiver in a vehicle, comprising:
a standalone portable device having memory for storing and independently presenting audio and data wirelessly received by the embedded radio receiver in the vehicle; and
a communication interface in the standalone portable device for receiving audio and data received at the embedded radio receiver when coupled to the embedded radio receiver and for transferring audio and data to and from a computer network when coupled to the computer network and further for uploading stored audio and data to a user interface coupled to the embedded radio receiver when coupled to the embedded radio receiver.

13. The remote application server of claim 12, wherein the server further comprises a processor in the standalone portable device for remotely running applications on the standalone portable device that are presented on the user interface coupled to the embedded radio receiver via a thin client resident in the user interface or embedded radio receiver in the vehicle.

14. The remote application server of claim 12, wherein the server further comprises a thin client resident in the portable standalone device that uses a processor resident in the vehicle for running applications on the user interface or the embedded radio receiver that are presented on a user interface integrated with the standalone portable device via the thin client.

15. The remote application server of claim 14, wherein the remote application server system receives and uploads data to the user interface including traffic, gas prices, movie schedules or flight delays.

16. The remote application server of claim 12, wherein the standalone portable device further operates as an independent portable digital audio recorder and player.

17. The remote application server of claim 12, wherein the standalone portable device, the embedded radio receiver and the user interface communicate selectively via a proprietary communication link in the form of a digital transceiver and a standard communication link in the form of a universal serial bus.

18. The remote application server of claim 12, wherein the standalone portable device records multiple radio channels simultaneously received at the embedded radio receiver.

19. The remote application server of claim 12, wherein the standalone portable device remotely controls hardware and software functions on the user interface in the vehicle.

20. A connector arrangement between portable digital products and embedded automotive informational products, comprising:
a universal serial bus interface;
a secondary communication link compatible with the universal serial bus interface;
a mechanism for detecting the coupling of a universal serial bus connector or a connector using the secondary communication link compatible with the universal bus connector;
a switch mechanism for selectively enabling a link via secondary communication link when detecting the secondary communication link and enabling a connection via the universal serial bus interface when detecting a universal serial bus connector.

21. The connector of claim 20, wherein the secondary connector is a digital transceiver.

22. The connector of claim 20, wherein the secondary connector is a digital transceiver that provides a digital audio or data stream to and from a portable product and an embedded automotive informational product.

23. A method of remotely interfacing with a vehicle infotainment system having an embedded radio receiver in a vehicle, comprising the steps of:
storing and independently presenting audio and data wirelessly received by the embedded radio receiver in the vehicle in a standalone portable server having memory;
presenting audio and data in a user interface having a display coupled to the embedded radio receiver in the vehicle; and
enabling a communication interface in the standalone portable server for receiving audio and data received at the embedded radio receiver when coupled to the embedded radio receiver and for receiving audio and data from a computer network when coupled to the computer network and further for uploading stored audio and data to the user interface when coupled to the embedded radio receiver.

24. The method of claim 23, wherein the method further remotely runs applications on the standalone portable server that are presented on the user interface coupled to the embedded radio receiver via a thin client resident in the user interface or embedded radio receiver in the vehicle.

25. The method of claim 23, wherein the method further uses a processor resident in the vehicle for running applications on the user interface or the embedded radio receiver that are presented on a user interface integrated with the standalone portable server via a thin client resident in the standalone portable server.
